(19) United States
(12) Patent Application Publication
(10) Pub. No.: US 2013/0073847 A1
(43) Pub. Date: Mar. 21, 2013

(54) ENCRYPTION AUTHENTICATION OF DATA TRANSMITTED FROM MACHINE VISION TOOLS

(71) Applicant: Timothy Scherer, Portland, OR (US)

(72) Inventor: Timothy Scherer, Portland, OR (US)

(73) Assignee: COGNEX CORPORATION, Natick, MA (US)

(21) Appl. No.: 13/612,111

(22) Filed: Sep. 12, 2012

Related U.S. Application Data
(60) Provisional application No. 61/534,368, filed on Sep. 13, 2011.

(51) Int. Cl. H04L 9/00

(52) U.S. Cl. 713/160; 713/150

(57) ABSTRACT

The technology provides, in some aspects, methods and systems for securely transmitting data using a machine vision system (e.g., within a pharmaceutical facility). Thus, for example, in one aspect, the technology provides a method that includes the steps of establishing a communications link between a machine vision processor and a remote digital data processor (e.g., a database server, personal computer, etc.); encrypting, on the machine vision processor, (i) at least one network packet containing machine vision data, and (ii) at least one network packet containing non-machine vision data; and sending to the remote digital data processor the encrypted network packets from the machine vision processor.

### RELATED APPLICATION

This application claims the benefit of priority of U.S. Patent Application Ser. No. 61/534,368 filed Sep. 13, 2011, entitled “Encryption Authentication of Data Transmitted from Machine Vision Tools,” the entirety of which is incorporated herein by reference.

### TECHNICAL FIELD

The technology pertains to machine vision systems and, more particularly, to methods and apparatus for transmitting digital data between a machine vision system and other devices or computers on a network. The technology has applicability in numerous fields, including manufacturing and quality control processes.

### BACKGROUND

Machine vision refers to the automated analysis of images to determine characteristics of objects represented in the images. It is often employed in automated manufacturing and/or distribution lines, where images of objects are captured and analyzed (e.g., to check for defects). Examples of such machine vision systems are provided in prior works of the assignee, Cognex Corporation, such as U.S. Pat. No. 6,175,652, entitled, “Machine vision system for analyzing features based on multiple object images,” and U.S. Pat. No. 6,483,935, entitled “System and method for counting parts in multiple fields of view using machine vision.”

The images captured by the machine vision systems, and the associated analysis performed thereon, are typically stored, at least temporarily, in a database system within the manufacturing or distribution facility. Information security is an important concern for many of these facilities, and facility owners commonly protect communications between the facility and the outside world (e.g., with firewalls).

### SUMMARY

In one aspect of the technology, a computerized method is provided for securely sending data using a machine vision system (e.g., within a pharmaceutical facility). More specifically, the method includes the steps of establishing a communications link between a machine vision processor and a remote digital data processor (e.g., a database server, personal computer, etc.); encrypting, on the machine vision processor, (i) at least one network packet containing machine vision data, and (ii) at least one network packet containing non-machine vision data; and sending to the remote digital data processor the encrypted network packets from the machine vision processor.

Related aspects of the technology provide authenticating the machine vision processor as a source of the network packets sent to the remote digital data processor.

Further related aspects of the technology provide decrypting, on the remote digital data processor, the network packets. Related aspects of the technology provide for storing the resulting unencrypted data in a data store.

Still further related aspects of the technology provide network packets comprised of Internet Protocol (IP) packets. Related aspects of the technology provide encrypting the network packets using the Internet Protocol Security (IPSec) protocol suite. Further related aspects of the technology provide performing the encrypting step by encrypting both a header and a payload of (i) at least one IP packet containing machine vision data, and (ii) at least one IP packet containing non-machine vision data.

Still yet further related aspects of the technology provide capturing an image of an object with an image acquisition device associated with the vision processor, the image comprising at least a portion of the machine vision data. Related aspects of the technology provide performing, with the vision processor, a machine vision function on the image, a result of that machine vision function comprising at least a portion of the machine vision data. Further related aspects of the technology provide such methods wherein the machine vision function recognizes patterns in the image, the patterns including any of letters, numbers, symbols, corners, or other discernable features of the object, and a result of that function comprises at least a portion of the machine vision data.

In other aspects of the technology, a method is provided for securely receiving data using a machine vision system (e.g., within a pharmaceutical facility). More specifically, the method includes the steps of establishing a communications link between a machine vision processor and a remote digital data processor; receiving, on the machine vision processor, (i) at least one encrypted network packet containing machine vision data, and/or (ii) at least one encrypted network packet containing non-machine vision data; and decrypting, on the machine vision processor, the received network packets.

Related aspects of the technology provide authenticating a source of the network packets prior to receiving the packets.

Further related aspects of the technology provide the vision processor storing the resulting unencrypted data in an associated memory.

In still other aspects of the technology, a computerized method is provided for inspecting an object using a machine vision system (e.g., within a pharmaceutical facility). More specifically, the method includes the steps of providing machine vision data generated by the machine vision system to a machine vision processor, the machine vision data corresponding to a pharmaceutical object; establishing a secure communications link between the machine vision processor and a remote digital data processor; encrypting, on the machine vision processor, (i) at least one network packet containing a portion of the machine vision image data, and (ii) at least one network packet containing non-machine vision image data; authenticating the machine vision processor as a source of the encrypted network packets transmitted to the remote digital data processor; and sending to the remote digital data processor via the secure communication link, the encrypted network packets generated by the machine vision processor.

Related aspects of the technology provide decrypting, on the remote digital data processor, the received authenticated network packets.

Further related aspects of the technology provide an object for inspection that includes any of (i) a label containing pharmaceutical information, (ii) a container for storing pharmaceuticals, and (iii) a pharmaceutical.

Still further related aspects of the technology provide capturing an image of the pharmaceutical object with an image acquisition device associated with the vision processor, the image comprising at least a portion of the machine vision data. Related aspects of the technology provide performing, with the vision processor, a machine vision function on the image, a result of that machine vision function comprising at least a portion of the machine vision data. Further related aspects of the technology provide a machine vision function that recognizes patterns in the image, the patterns including any of letters, numbers, symbols, corners, or other discernable features of the pharmaceutical object, a result of that function comprising at least a portion of the machine vision data.

In yet still other aspects of the technology, a machine vision system is provided for secure data transmission (e.g., within a pharmaceutical facility) that includes a machine vision processor in data communication with a remote digital data processor via a network link. The machine vision processor, based upon a set of one or more security rules, encrypts the network link including (i) at least one network packet containing machine vision data, and (ii) at least one network packet containing non-machine vision data. The machine vision processor further sends the encrypted network packets to the remote digital data processor, which, based upon the security rules, (i) authenticates the machine vision processor as an authorized source of communication network transmissions, (ii) receives the encrypted network packets from the machine vision processor, and (iii) decrypts the network packets.

Related aspects of the technology provide for systems as described above in which the remote digital data processor, based upon the security rules, authenticates a source of the transmitted network packets as that of the machine vision processor.

Further related aspects of the technology provide for systems as described above in which the remote digital data processor stores the resulting unencrypted data in an associated memory.

Still further related aspects of the technology provide for systems as described above in which the network packets comprise Internet Protocol (IP) packets. Related aspects of the technology provide such systems in which the machine vision processor, based upon the security rules, encrypts both a header and a payload for (i) at least one network packet containing machine vision data, and (ii) at least one network packet containing non-machine vision data. In further related aspects of the technology, such systems as described above are provided in which the set of one or more security rules comprise rules based on the Internet Protocol Security (IPSec) protocol suite.

In still other aspects of the technology, a machine vision system is provided for secure data receipt (e.g., within a pharmaceutical facility) that includes a machine vision processor in data communication with a remote digital data processor via a network link. The machine vision processor, based upon a set of one or more security rules, receives one or more network packets from the remote digital data processor, at least one of which is encrypted, and, based upon the security rules, decrypts the encrypted network packets.

Related aspects of the technology provide for systems as described above in which the machine vision processor, based upon the security rules, authenticates the remote digital data processor as an authorized source of network transmissions.

Further related aspects of the technology provide for systems as described above in which the machine vision processor, based upon the security rules, authenticates a source of the transmitted network packets as that of the machine vision processor.

Still further aspects of the technology provide for systems as described above in which the machine vision processor stores the resulting unencrypted data in an associated memory.

These and other aspects of the technology are evident in the drawings and text that follow.

### BRIEF DESCRIPTION OF THE DRAWINGS

A more complete understanding of the technology can be attained by reference to the drawings, in which:

FIG. 1 depicts a machine vision system and environment for securely sending and receiving digital data over a network according to one practice of the technology;

FIG. 2 depicts a configuration and operation of a vision processor for securely sending digital data to a remote device over a network according to one practice of the technology; and

FIG. 3 depicts a configuration and operation of a vision processor for securely receiving digital data from a remote device over a network according to one practice of the technology.

### DETAILED DESCRIPTION

Architecture

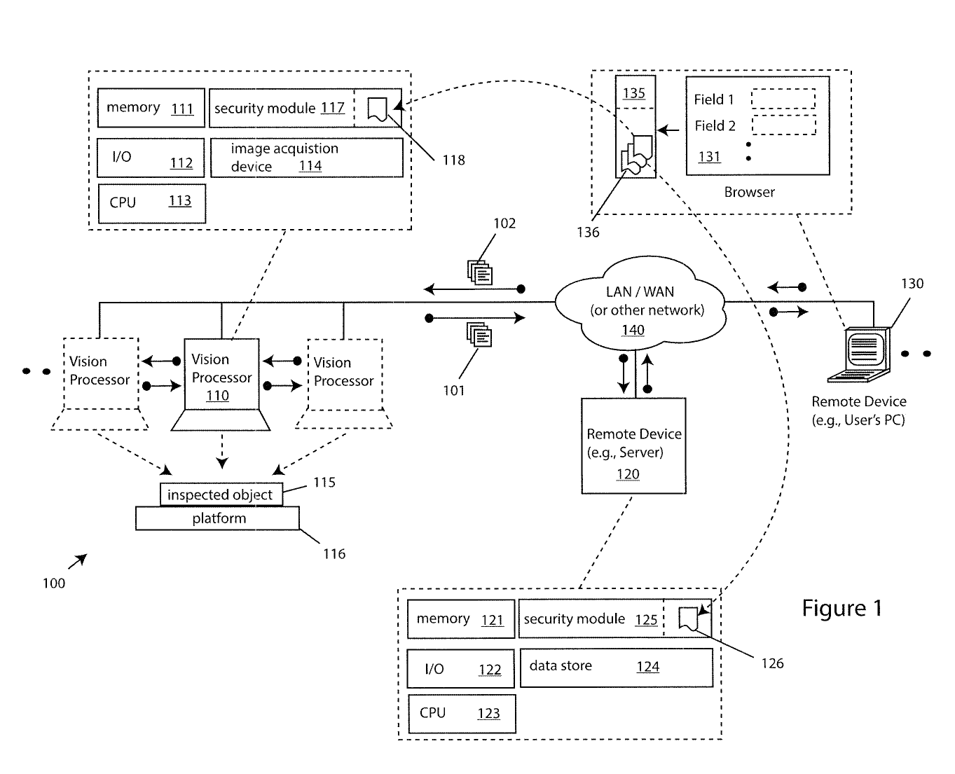

FIG. 1 depicts a machine vision system and environment 100 for securely transmitting information 101, 102 between one or more vision processors 110 and one or more remote digital data processors 120, 130 according to one embodiment of the technology. In the illustrated embodiment, the environment 100 is within a pharmaceutical facility, such as a pharmaceutical manufacturing plant or a pharmaceutical distribution center. Of course, in other embodiments, the environment 100 can be disposed within any other type of facility that could benefit from machine vision systems (e.g., a semiconductor manufacturing plant, an automobile assembly plant, etc.). Secure communication within the facility itself, as opposed to simply between the facility and the outside world, is particularly helpful in pharmaceutical environments, which can require increased security measures due to confidentiality and other privacy concerns specific to the health care field.

In the illustrated embodiment, the information 101, 102 comprises digital data that can be transmitted over a network 140, such as the Internet, local-area network (LAN) or wide-area network (WAN), or otherwise, that can be public, private, IP-based, etc. As shown, the network 140 is IP-based, so the information 101, 102 is transmitted via IP network packets, although in other embodiments, different types of networks and/or packets can be used. For example, the information 101, 102 can include machine vision data (e.g., camera images, custom data, and/or results calculated by vision processor 110, etc.) and/or non-machine vision data (e.g., generic IP network traffic, security rules, etc.).

With continued reference to the information 101, 102, all of the information (i.e., the entire network stream) can be encrypted, or only a portion of the information can be encrypted. The information 101, 102 can also be authenticated, to ensure that it came from an appropriate sender, e.g., rather than from an intermediary posing as the sender. Encryption and authentication can be applied together or separately, depending on situational security requirements, as discussed further below.

The system 100 includes a vision processor (VP) 110 connected to network 140. The illustrated VP 110 is configured to inspect and image an object 115 on a platform 116 in a manner consistent with machine vision systems known in the art. The VP 110 includes a memory 111, I/O 112, CPU 113. The VP 110 further includes an image acquisition device 114 and a security module 117. Although each of these components 111-119 are shown and described in a single unitary structure, in other embodiments the components can be distributed among several devices and, for example, connected over a network. Those skilled in the art will also appreciate that the system 100 can be configured to use a single VP 110 or multiple VPs.

Illustrated image acquisition device 114 is a machine vision camera or other device capable of acquiring images of object 115 on platform 116 in the visible or other relevant spectrum. In multi-camera systems, the cameras are disposed to acquire images of object 115 from different respective viewpoints. The image acquisition device 114 typically includes a lens and other image acquisition components (e.g., a charge coupled device (CCD) or other capture medium) of the type known in the art of machine vision systems.

Illustrated object 115 is a pharmaceutical object, although in other embodiments it can be any other type of object that can benefit from machine vision imaging (e.g., a semiconductor wafer, automobile part, etc.). For example, the object 115 can include a container for holding pharmaceuticals (e.g., a “pill bottle”), a label or bar-code indicating pharmaceutical information (e.g., a type of pharmaceutical, a brand name, a manufacturing date, a dosage amount, etc.), or an actual pharmaceutical itself (e.g., a pill). As shown, the object 115 is disposed on a platform 116, such as a chuck or a motion stage. Although in other embodiments, the object 115 can be disposed directly on a conveyer belt or otherwise.

Illustrated security module 117 executes a set of security and configuration rules 118 (collectively, “security rules 118”) used to encrypt, decrypt, authenticate, and/or otherwise secure communications between the VP 110 and one or more remote devices (e.g., server 110, personal computer 120), vision processors, and/or other networked devices. The security module 117 implements an Internet Protocol Security (IPSec) protocol suite in the VP's 110 firmware, and the security rules 118 comprise IPSec rules. For example, NanoSec, a third-party library from Mocana can be used. In other embodiments, the security module 117 can use other security protocols and/or rules, IP-based or otherwise, and can be implemented in the firmware or elsewhere. The security rules 118 can come “factory-installed” on the VP 110, and/or configured otherwise, e.g., by a user operating the remote device 130, as discussed further below. Those skilled in the art will appreciate that in other embodiments, the functionality of the security module 117 can be found in another component of the VP 110, e.g., I/O 112 or CPU 113, or in an associated device.

Illustrated remote devices 120, 130 comprise a database server 120 and a personal computer (PC) 130 connected to the network 140, although those skilled in the art will appreciate that other embodiments can include different types of devices (e.g., laptops, etc.), and/or a greater or lesser number of such devices. The server 120 is used to store, among other things, machine vision data, such as images captured by acquisition device 114, and/or image analysis, reports and calculations generated by the VP 110. Server 120 includes a memory 121, I/O 122, CPU 123, and data store 124, all of type known in the art.

The remote devices 120, 130 each further include a security module 125 and 135, respectively, that execute a set of security and configuration rules 126, 136 (collectively, “security rules 126” and “security rules 136”) used to encrypt, decrypt, authenticate, and/or otherwise secure communications between the VP 110 and the remote devices 120, 130, and between the remote devices 120 and 130 themselves. The security modules 125, 135 implement an IPSec protocol suite, e.g., Nanosec, and the security rules 126, 136 comprise IPSec rules. In other embodiments, the security modules 125, 135 can use other security protocols and/or rules, IP-based or otherwise.

The remote device 130 is typically operated by a user (e.g., an engineer, a systems administrator, etc.) to, for example, view machine vision images captured by the VP 110, results or analysis calculated by the VP 110, and/or configure security rules 118, 125, 136. In the illustrated embodiment, a user can use the input application 131 to add, delete, or modify security rules 118, 125, 136 executed on the VP 110 and remote devices 120, 130. For example, the input application 131 can be a web browser, text editor, custom or generic Windows OS application, or other application designed to take input from a user.

Security Rules

In the illustrated embodiment, the rules 118, 126, 136 define security policies for their associated device, namely VP 110, server 120, and PC 130, respectively. More specifically, the security rules 118, 126, 136 individually define policies for inbound and outbound network traffic or, alternatively, “mirrored policies,” which apply a single rule to both inbound and outbound network traffic. For example, the security rules 118, 126, 136 can define any of the following rule elements:

A network name of a VP 110 and/or remote devices 120, 130.

A network address (e.g., IP address), or a range of network addresses, of VP 110 and/or remote devices 120, 130.

A port number and/or a range or port numbers for a source device (e.g., VP 110) and a destination device (e.g. server 130).

Which network protocols to secure (e.g., Any, TCP or UDP; default=Any).

Which authentication algorithms to apply. In the illustrated embodiment, the security modules 117, 125 and 135 support rules for Authentication Headers (AH) and Encapsulating Security Payload (ESP) in Transport and/or Tunnel mode, with shared keys; the MD5 and SHA1 algorithms for authentication. In other embodiments, different authentication algorithms can be used.

Which encryption algorithms to apply. In the illustrated embodiment, the security modules 117, 125 and 135 support rules for DES, 3DES (Triple DES), Blowfish and the AES algorithm. In other embodiments, different encryption algorithms can be used.

The encryption and/or authentication key shared between the vision processor 110 and a remote device 120, 130. This specifies the key that will be shared between a source device and a destination device. In encryption, a key is a string or number used in the encryption and decryption algorithms. Typically, the key is secured, because anyone in possession of the key can decrypt transmissions encrypted with that key.

Whether or not to enable a security rule for a particular device (e.g., VP 110, remote devices 120, 130, etc.).

Those skilled in the art will appreciate that in other embodiments the above rule elements can be defined otherwise as necessary to achieve the encryption and authentication described herein.

Operation

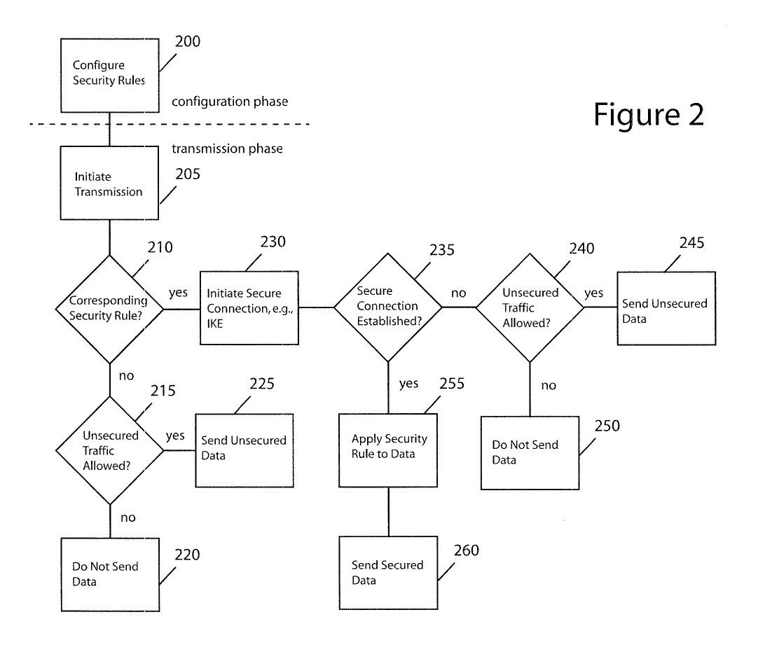

FIG. 2 is a flow diagram depicting a configuration and operation of the VP 110 for sending digital data 101 from the VP 110 to the remote device 120 over the network 140 according to one practice of the technology. Those skilled in the art will appreciate that this is but an exemplary depiction, and in practice the VP 110 can send digital data to other remote devices (e.g., PC 130) or other virtual processors as well.

In step 200, the security rules 118 are configured to define rules for inbound and outbound network traffic for the VP 110. As discussed above, the rules 118 can come factory-installed on the VP 110, and/or they can be configured by a user, e.g., operating remote device 130, as illustrated in FIG. 1. Thus, for example, a user needing strict security can add a rule to the rule set 118 that requires the VP 110 to only send encrypted data.

In step 205, the VP 110 initiates a transmission to the server 120 in response to a particular event. For example, the VP 110 can initiate a transmission to the server 120 after the image acquisition device 114 acquires an image of the object 115. By way of further example, the VP 110 can initiate a transmission after executing a machine vision tool (e.g., a pattern matching function performed on an image of an object). Of course these are but a few examples, and the VP 110 can initiate a transmission in response to other events, or by other means. With respect to FIG. 2, the VP 110 initiated a transmission to server 120.

Upon initiating the transmission phase, the security module 117 checks the security rules 118 for a rule matching a destination device for the information 101, as indicated in step 210. In the illustrated embodiment, the security module 117 compares an identifier of the destination device, e.g., a network name or network address, and performs a lookup in the rules 118 for a rule matching that identifier. The VP 110 is attempting to send the information 101 to the server 120, so the module 117 performs a lookup in the rule set 118 for a rule matching the server 120 identifier.

If the security rule set 118 does not contain a security rule corresponding to the server 120, then the check in step 210 will fail, and a secure connection will not be established between the VP 110 and the server 120. The security module 117 will then check the rules 118 to determine if unsecured outgoing traffic is permitted on the VP 110, as indicated in step 215, in order to determine if the data 101 will still be sent to the server 120, albeit in an unencrypted form.

By default, all outgoing traffic from the VP 110 can still be sent in an unsecured form, i.e., without any encryption/authentication, unless the security module 117 contains a rule that holds otherwise. If such a rule exists, e.g., requiring all outgoing traffic from the VP 110 to be encrypted and/or authenticated, then the transmission terminates, and the VP 110 does not send the data 101 to the server 120, as indicated in step 220. Alternatively, if there is no such rule, or there is a rule specifically permitting unsecured outgoing traffic, then the VP 110 sends the data 101, via I/O 112, to the server 120 in an unsecured form over network 140, as shown in step 225.

Returning to step 210, if the lookup succeeds, and the rule set 118 contains a rule matching server 120, then the security module 117 will attempt to initiate a secure network connection with the server 120, as indicated in step 230. In the illustrated embodiment, the security module 117 uses the Internet Key Exchange (IKE) protocol to establish such a secure connection, although other embodiments can use different protocols. More specifically, IKE uses a key exchange algorithm to generate a shared secret key to encrypt further IKE communications. This negotiation results in one single bi-directional ISAKMP Security Association (SA). The authentication can be performed using a pre-shared key (shared secret), signatures, or public key encryption.

If the secure connection fails, e.g., because the keys do not match, the VP 110 will not send any secured data to the server 120. Like step 215 above, the security module 117 will check the rules 118 to determine if unsecured outgoing traffic is permitted on the VP 110, as indicated in step 240. If the rules 118 permit such traffic, the VP 110 will send the unsecured data 101, via I/O 112, to the server 120 over network 140, as indicated in step 245. However, if the rules 118 do not permit unsecured outgoing traffic, the data 101 will not be sent to the server 120, as indicated in step 250.

Alternatively, if a secure connection is successfully established between the VP 110 and the server 120, then the security module 117 will modify and/or encrypt the data 101 per the matching security rule, as shown in step 255. In the illustrated embodiment, the security module 117 can encrypt and/or modify the data 101, depending on security rule definition, by either (1) encrypting the payloads of the network packets, and leaving the headers intact; or (2) encrypting the packets in their entirety, and then encapsulating them into new packets with new headers. In different embodiments, the data can be encrypted and/or modified otherwise. For example, the security module 117 can encrypt the data 101 with DES, 3DES, Blowfish, or the AES encryption algorithm.

As mentioned above, the security module 117 can encrypt all of the data 101 sent to the server 120 (e.g., machine vision data and non-machine vision data), or it can only encrypt a portion thereof (e.g., only machine vision data), depending on how the matching security rule is defined. The security module 117 can also modify the data 101 to include authentication data, e.g., an identifier of the VP 110, which the server 120 can use to authenticate a source of incoming data. Once the data 101 is appropriately modified and/or encrypted, the VP 110 sends the data 101, via I/O 112, to the server 120, as shown is step 260. However, in the event that a portion of the data 101 is encrypted and a portion of the data 101 is not encrypted, the VP 110 will send the unencrypted portion only if the VP 110 is permitted to send unencrypted data. Otherwise, the VP 110 will send only the encrypted portion of the data 101.

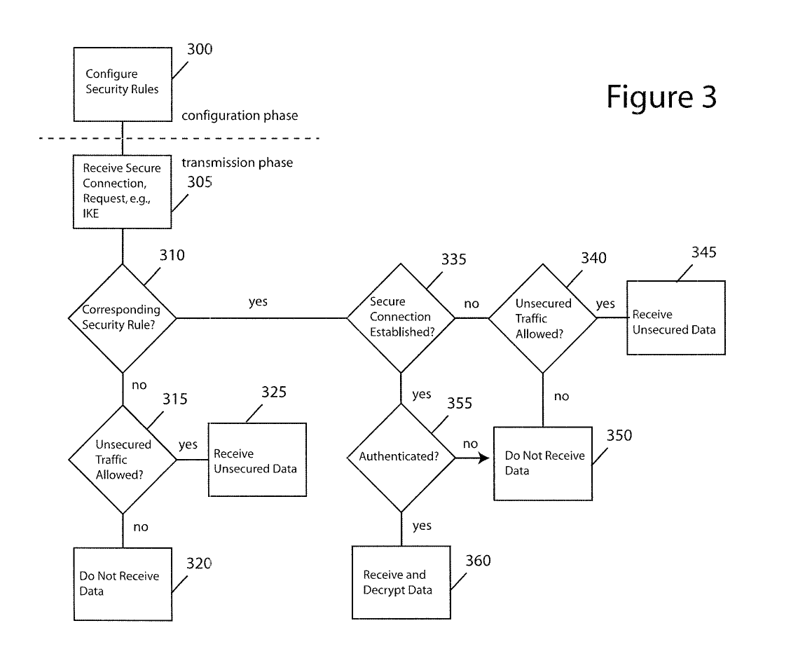

Although not shown in FIG. 2, it will be appreciated that the server 120 will receive the data 101, via I/O 122, and decrypt and/or authenticate the data 101 using security module 125. Decryption and authentication on the server 120 is performed in a similar manner as performed on the VP 110, discussed further below with reference to FIG. 3.

FIG. 3 depicts a configuration and operation of the VP 110 for securely receiving, at the VP 110, digital data 102 from the remote device 120 over the network 140 according to one practice of the technology. Those skilled in the art will appreciate that this is but an exemplary depiction, and in practice the VP 110 can receive digital data from other devices as well (e.g., PC 130, other VPs, etc.).

In step 300, the security rules 118 are configured to define policies for inbound and outbound network traffic for the VP 110, as discussed above in reference to FIG. 2.

In step 305, the VP 110 begins a data receiving phase of operation after receiving a request (e.g., in the form of IP or other network packets) to complete a secure connection initiated by a remote device, e.g., via IKE. With respect to FIG. 2, the VP 110 has received a secure connection request from the server 120.

Upon receiving a secure connection request, the security module 117 inspects the request (e.g., IP packets) for an identifier of the remote device that initiated the request. In the illustrated embodiment, the identifier is a network name or network address, although other embodiments can user other identifiers (e.g., ports, etc.). The security module 117 performs a lookup on the security rules 118 for a rule matching that identifier. The security module 117 is looking for a rule matching the server's 120 identifier.

If the security rules 118 do not contain a security rule matching the server 120 identifier, then the check in step 310 fails, and a secure connection is not established between the VP 110 and the server 120. The security module 117 then checks the rules 118 to determine if unsecured incoming traffic is permitted on the VP 110, as indicated in step 315, in order to determine if the data 102 can still be received by the VP 110, albeit in an unencrypted form.

By default, all incoming traffic on the VP 110 can still be received in an unsecured form, i.e., without any encryption/authentication, unless the security module 117 contains a rule that holds otherwise. If such a rule exists, e.g., requiring all incoming traffic on the VP 110 to be encrypted and/or authenticated, then the transmission terminates, and the VP 110 rejects the data 102, as indicated in step 320. Alternatively, if there is no such rule, or there is a rule specifically permitting unsecured incoming traffic, then the VP 110 receives the data 102 from the server 120 in an unsecured form, as shown in step 325.

Returning to step 310, if the check succeeds, and the rule set 118 contains a rule matching the server 120 identifier, then the security module 117 will attempt to complete the secure network connection initiated by the server 120, as indicated in step 335. If the secure connection fails, e.g., because the keys do not match, a secure connection will not be established, and the VP 110 will not receive any secured data from the server 120. Like step 315 above, the security module 117 will then check the rules 118 to determine if unsecured incoming traffic is permitted on the VP 110, as indicated in step 340. If the rules 118 permit such traffic, the VP 110 will receive the unencrypted data 102, e.g., via I/O 112, from the server 120, as indicated in step 345. However, if the rules 118 do not permit unsecured incoming traffic, the VP 110 will reject the data 102, as indicated in step 350.

Alternatively, with continued reference to step 340, if a secure connection is successfully established between the VP 110 and the server 120, then the VP 110 will receive and decrypt the data 102 per the matching security rule, as shown in step 360, unless the security rule additionally requires the module 117 to authenticate the data 102. If the matching security rule does indeed require authentication, the security module 117 will apply an authentication algorithm specified in the matching rule, e.g., MD5, to confirm that (1) the data 102 did in fact originate at the server 120, as opposed to some other device, and/or (2) that the server 120 is an authorized sender of data. For example, the security module 117 can inspect the data 102 for an identifier of the server 120, e.g., a network name or address, which the server 120 embedded into the data 102 with security module 125.

If the authentication in step 355 is successful, then the VP 110 will receive and decrypt the data 102 per the matching security rule, as indicated in step 360. Alternatively, if the authentication fails, e.g., because the VP 110 is actually the subject of a “man in the middle attack,” then the VP 110 will reject the data 102, as indicated in step 350.

Hardware and Software Considerations

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and anyone or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touch pad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the technology can be embodied in other specific forms without departing from the spirit or essential characteristics thereof. The foregoing embodiments are therefore to be considered in all respects illustrative rather than limiting of the technology described herein. Scope of the technology is thus indicated by the appended claims, rather than by the foregoing description, and all changes that come within the meaning and range of equivalency of the claims are therefore intended to be embraced therein.

It will be appreciated that the illustrated embodiment and those otherwise discussed herein are merely examples of the technology and that other embodiments, incorporating changes thereto, fall within the scope of the technology.

In view of the foregoing, what I claim is:

1. A computerized method for securely transmitting data using a machine vision system, comprising:
A) establishing a communications link between a machine vision processor and a remote digital data processor;
B) encrypting, on the machine vision processor, (i) at least one network packet containing machine vision data, and (ii) at least one network packet containing non-machine vision data; and
C) sending to the remote digital data processor the encrypted network packets from the machine vision processor.

2. The computerized method of claim 1, further comprising authenticating the machine vision processor as a source of the network packets sent to the remote digital data processor.

3. The computerized method of claim 1, wherein the network packets comprise Internet Protocol (IP) packets.

4. The computerized method of claim 3, wherein the IP packets are encrypted using the Internet Protocol Security (IPSec) protocol suite.

5. The computerized method of claim 3, wherein the encrypting step further includes encrypting both a header and a payload of (i) at least one IP packet containing machine vision data, and (ii) at least one IP packet containing non-machine vision data.

6. The computerized method of claim 1, further comprising capturing an image of an object with an image acquisition device associated with the vision processor, the image comprising at least a portion of the machine vision data in step (B).

7. The computerized method of claim 6, further comprising performing, with the vision processor, a machine vision function on the image, a result of that machine vision function comprising at least a portion of the machine vision data in step (B).

8. The computerized method of claim 7, wherein the machine vision function comprises a function that recognizes patterns in the image, the patterns including any of letters, numbers, symbols, corners, or other discernable features of the object, a result of that function comprising at least a portion of the machine vision data in step (B).

9. The computerized method of claim 1, further comprising receiving, on the machine vision processor, (i) at least one encrypted network packet containing machine vision data, and/or (ii) at least one encrypted network packet containing non-machine vision data.

10. The computerized method of claim 9, further comprising decrypting, on the machine vision processor, the received network packets.

11. The computerized method of claim 10, further comprising authenticating a source of the network packets prior to receiving the packets.

12. The computerized method of claim 10, further comprising the vision processor storing the resulting unencrypted data in an associated memory.

13. A computerized method for inspecting an object using a machine vision system, comprising:
A) providing machine vision data generated by the machine vision system to a machine vision processor, the machine vision data corresponding to an object;
B) establishing a secure communications link between the machine vision processor and a remote digital data processor;
C) encrypting, on the machine vision processor, (i) at least one network packet containing a portion of the machine vision image data, and (ii) at least one network packet containing non-machine vision image data;
D) authenticating the machine vision processor as a source of the encrypted network packets transmitted to the remote digital data processor; and
E) sending to the remote digital data processor via the secure communication link, the encrypted network packets generated by the machine vision processor.

14. The computerized method of claim 13, further comprising decrypting, on the remote digital data processor, the received authenticated network packets.

15. The computerized method of claim 13, wherein the object includes any of (i) a label containing information of the object, and (ii) a container for storing objects.

16. A machine vision system providing secure data transmission, comprising:
A) a machine vision processor in data communication with a remote digital data processor via a network link;
B) a set of one or more security rules;
C) the machine vision processor, based upon the security rules, encrypting the network link including (i) at least one network packet containing machine vision data, and (ii) at least one network packet containing non-machine vision data;
D) the machine vision processor sending the encrypted network packets to the remote digital data processor; and
E) the remote digital data processor, based upon the security rules, (i) authenticating the machine vision processor as an authorized source of communication network transmissions, (ii) receiving the encrypted network packets from the machine vision processor, and (iii) decrypting the network packets.

17. The system of claim 16, further comprising the machine vision processor, based upon the security rules, encrypting both a header and a payload for (i) at least one network packet containing machine vision data, and (ii) at least one network packet containing non-machine vision data.

18. The system of claim 17, further comprising the machine vision processor, based upon the security rules, (i) receiving one or more network packets from the remote digital data processor, at least one of which is encrypted.

19. The system of claim 18, further comprising the machine vision processor, based upon the security rules, authenticating a source of the received network packets as that of the machine vision processor.

20. The system of claim 19, further comprising the machine vision processor, based upon the security rules, decrypting the authenticated network packets.
